(19) United States
(12) Patent Application Publication
(10) Pub. No.: US 2018/0369770 A1
(43) Pub. Date: Dec. 27, 2018

(54) DEVICE AND METHOD FOR PROCESSING THERMOPLASTIC MATERIAL WITH A TEMPERATURE CONTROL DEVICE FOR A CONVEYING SCREW

(71) Applicant: Next Generation Recyclingmaschinen GmbH, Feldkirchen an der Donau (AT)

(72) Inventors: Klaus BRZEZOWSKY, Marchtrenk (AT); Klemens GRUBER, Rainbach (AT); Thomas PICHLER, St. Peter am Wimberg (AT)

(73) Assignee: Next Generation Recyclingmaschinen GmbH, Feldkirchen an der Donau (AT)

(21) Appl. No.: 15/778,262

(22) PCT Filed: Nov. 24, 2016
(86) PCT No.: PCT/EP2016/078622

§ 371 Date: Jun. 19, 2018

(30) Foreign Application Priority Data
Nov. 24, 2015 (AT) A 51001/2015

(51) Int. Cl. B01F 15/02; B29B 17/00; B01F 7/24; B01F 3/20; B01F 15/00

(52) U.S. Cl. CPC B01F 15/0251; B29B 17/0036; B01F 7/248; B01F 3/2078; B01F 2215/0049; B01F 15/00201; B01F 15/00207; B01F 15/00396; B01F 3/2014

(57) ABSTRACT

The invention relates to a device (1a . . . 1g) for processing thermoplastic material, comprising a storage container (2)/a conveying line (11) for plastic particles and a conveying screw (3) connected thereto. The device (1a . . . 1g) further comprises an extruder (4) which connects to the conveying screw (3), and a tempering device (7) arranged in the course of the conveying screw (3). In addition, a temperature sensor (8, 8a, 8b) is arranged in the course of the conveying screw (3)/the extruder (4), and/or means (10) are provided for detecting a load of a drive (6) of the extruder (4). Finally, the device (1a . . . 1g) comprises means for influencing the tempering device (7) and an open loop control/closed loop control (9) which is connected to the at least one temperature sensor (8, 8a, 8b) and/or the influencing means of the tempering device (7). Furthermore, an operating method for the device (1a . . . 1g) is specified, in which the plastic particles are temperature-controlled by a tempering device (7) in the course of the conveying screw (3).

The invention relates to a device for processing thermoplastic material, which comprises a storage container for receiving plastic particles or a conveying line for the transport of plastic particles, a conveying screw connected to the storage container/to the conveying line at a transfer opening, and an extruder which connects to the conveying screw. In addition, the invention relates to a method for operating the above device.

A device and a method of the above-mentioned type are basically known from the prior art. For example, EP 0 934 144 B1 discloses for this a device for processing thermoplastic material. The device comprises a machine housing with a feed hopper and a driven pusher, which presses the plastic material, which is situated on a base plate and is to be processed, into a processing drum or respectively into a conveying tube. Blades are mounted in a helical manner on the processing drum. The blades and the conveying screw which connects thereto convey the broken up plastic material to a screw of an extruder, into which the plastic material is delivered.

A disadvantage in the known solutions in particular is the temperature at the inlet to the extruder, said temperature being difficult to predict and to regulate. This depends inter alia on the processed material (in particular on its thermal capacity), the throughput and also the shape and size of the plastic particles. By friction, shearing work and compression, a distinct heating can already occur in the conveying screw, so that the plastic particles stick together or become stuck to the extruder inlet and can clog the latter. Basically, however, it is also conceivable that the plastic particles are comparatively cold at the inlet of the extruder, for example if plastic with a very low temperature is delivered for further processing. As the extruder has only limited means for influencing the temperature, the reaching of a set-point temperature at the nozzle of the extruder according to the prior art can under some circumstances not be guaranteed in every case.

It is therefore an object of the invention to indicate an improved device and an improved method for processing thermoplastic material. In particular a set-point temperature is to be able to be reached with greater reliability in the extruder and/or at the inlet of the extruder and at its nozzle.

The problem of the invention is solved by a device of the type named in the introduction, which has a tempering device arranged in the course of the conveying screw and

a) at least one temperature sensor, which is arranged in the course of the conveying screw and/or in the course of the extruder, means for influencing the tempering device and an open loop control/closed loop control connected to the at least one temperature sensor and to the means for influencing the tempering device and/or

b) means for detecting a load of a drive of the extruder, means for influencing the tempering device and a closed loop control connected to the detection means and the influencing means.

The problem of the invention is solved furthermore by a method for operating the above device, in which the plastic particles are temperature-controlled in the course of the conveying screw by a tempering device.

Through the proposed provisions, a set-point temperature can be reached with greater reliability in the extruder and/or at the inlet of the extruder and at its nozzle. The tempering device can be formed for example by a heating device, a cooling device or a combined heating and cooling device.

The means for influencing the tempering device can be formed by an adjuster for the heating/cooling power, for example by a transistor or thyristor for adjusting a current through a heating coil of the tempering device. The influencing means could, however, for example also be formed by an electrical energy source which is adjustable with regard to voltage and/or current, to which energy source the heating coil is connected. If operation with a liquid or gaseous heat carrier is provided, the inflow to the tempering device can be adjustable by means of a valve which is connected into the flow or return, or else via the adjusting of an output of a pump or of a compressor, which is connected into the circuit of a heat carrier. It is also conceivable that the heat carrier can be directed in an adjustable manner via a bypass. Additionally or alternatively, provision can also be made that the temperature of the heat carrier is adjusted via the output of a heat exchanger, which is connected to the tempering device.

It is conceivable that the plastic particles which are fed to the extruder are cooled by means of the tempering device, for example if material with a very high temperature has been delivered and/or has low thermal capacity and/or has a lower melting temperature and/or has been heated excessively by friction, shearing work and compression in the conveying tube. Thereby, a clogging or sticking of the extruder inlet or respectively a sticking of the plastic particles on the latter is prevented or at least reduced.

Material which is fed to the extruder can, however, also be heated by means of the tempering device, for example if it has been delivered with a very low temperature and/or has high thermal capacity and/or has a high melting temperature and/or has not been heated in the conveying tube in the expected manner by friction, shearing work and compression.

Generally, the heating of the plastic particles takes place in the interior of the extruder by internal friction, wherein the drive power of the extruder is converted almost entirely into heat. In other words, the mechanically emitted motor output is converted almost entirely into thermal output, and the drive motor of the extruder acts de facto as heating. The longer the extruder is, all the more heat can be introduced into the plastic. Through the enormous shearing forces, in extreme cases also a negative impairment of the material quality can occur.

A comparatively high charging temperature of the extruder is now advantageous in so far as the material in the extruder is melted gently, because it arrives, already pre-warmed, into the extruder. Thereby, the drive power for the extruder can be reduced and also its overall length can be reduced. The energy consumption of the extruder per unit of weight of the extruded material is therefore likewise reduced and/or the material throughput is increased. In addition, the material wear in the extruder can also be reduced.

Ultimately, it is therefore also not always expedient to cool the plastic particles excessively in the conveying screw, in order to indeed prevent a sticking of the extruder inlet or respectively a sticking of the plastic particles to the latter. Rather, provision can be made that the temperature of the plastic particles at the extruder inlet is in fact so high that none of the mentioned negative phenomena occurs (excessively). Thereby, maintenance to the disclosed devices can be largely avoided, or respectively maintenance intervals can be extended, on the one hand owing to the extruder inlet remaining free, on the other hand also owing to the gentle mode of operation of the extruder.

In case a), the supply and/or removal of heat is adjusted or regulated directly as a function of a temperature of the plastic particles. In case b), in contrast, the supply and/or removal of heat is adjusted or regulated as a function of a load of the extruder and therefore indirectly via the temperature of the plastic particles. Here, the circumstance is utilized that the drive of the extruder, when the set-point temperature is reached in the extruder, is loaded in a characteristic manner. When the load lies above this characteristic value, this is an indication that the plastic particles are too cold and are not melted properly. When the load lies below this characteristic value, this is an indication that the plastic particles are too hot and are excessively fluid. Accordingly, in an advantageous method in case a) the removal of heat is intensified, when the temperature in the extruder and/or at the inlet of the extruder increases and vice versa. In an analogous manner, advantageously the removal of heat is intensified when the load in the extruder and/or at the inlet of the extruder reduces and vice versa.

Advantageous embodiments and further developments will now emerge from the subclaims and from the description, viewed together with the figures.

It is advantageous if the cooling power of the cooling device or of the combined heating and cooling device is greater than an power supplied to the plastic particles in the conveying screw by friction. Thereby, it is possible to cool the plastic particles before they enter into the extruder and to prevent or at least reduce a clogging or sticking of the extruder opening or respectively a sticking of the plastic particles on the latter. In a further preferred variant, the cooling power of the cooling device or of the combined heating and cooling device is greater than a drive power of the conveying screw. The latter is generally easier to determine than an power supplied to the plastic particles in the conveying screw by friction, whereby also the dimensioning of the cooling device or of the combined heating and cooling device is simplified. A slight oversizing which has possibly taken place thereby, can serve as security.

It is favourable if the at least one temperature sensor in case a) is arranged, in transport direction of the conveyed plastic particles, after the tempering device. In this way, the tempering device can be controlled. Basically, however, it is also possible that the at least one temperature sensor is arranged, in transport direction, before the tempering device. Such temperature sensors can likewise be included into the control of the tempering device. Of course, it is also possible merely to control the tempering device. In particular, the case is possible here that all temperature sensors are arranged, in transport direction, before the tempering device.

It is particularly advantageous if the at least one temperature sensor in case a) is arranged in the region of the transition between the conveying screw and the extruder. In this way, a predeterminable (set-point) temperature of the plastic particles which are fed to the extruder, can be maintained particularly well. Preferably, this type of control or respectively this control loop is combined with a further control loop which controls the heating in the extruder. The control loop of the conveying screw and the control loop of the extruder can operate independently of one another, or a further control loop can also be superordinate to the two control loops.

It is also conceivable that the temperature sensor in case a) is arranged in the course of the extruder, in particular in the region of the outlet or respectively of the nozzle. Thereby, the proper melting of the plastic particles can be regulated well. For example, the tempering device and a heating are provided in the extruder as actuating elements. In particular, the tempering device can be prioritized here, which means a heater of the extruder is only switched on when a heating through the tempering device is not sufficient.

In a particularly advantageous variant embodiment, the heat supply in case b) is increased when the load of the extruder increases, and vice versa. Accordingly, it is advantageous if the control is arranged to increase the heat supply through the tempering device when a load of the extruder increases and vice versa. Thereby, warmer material is, in turn, supplied to the extruder when its heating power is not sufficient for the proper melting of the plastic particles, and cooler material when the plastic particles are melted in the extruder excessively.

Generally, the open loop control/closed loop control of the tempering device can be based solely on a temperature measurement in or on the extruder, solely on a measurement of the load of the drive of the extruder or on a temperature measurement and a measurement of the load of the extruder drive.

It is favourable if for the determining of the load of the extruder a rotation speed of a drive of the extruder, a current received by this drive, or the torsion of a shaft in the drive is measured. For this purpose, a sensor for measuring a rotation speed of the drive of the extruder (e.g. a digital incremental encoder) can be provided, a sensor for measuring a current received by the drive (e.g. a voltage meter on a current-sensing resistor) or, for example, also a sensor for measuring the torsion of a shaft in the drive (e.g. a measuring bridge with strain gauge). Generally, the drive can also have a gear unit. The above-mentioned rotation speed and the above-mentioned torsion can therefore also be taken at a component in the gear unit. Generally, the extruder is then loaded more intensively if the rotation speed of the drive reduces, the current received by the drive increases or the torsion of a shaft in the drive increases.

Furthermore, it is particularly advantageous if
the type/sort of the processed plastic is identified by a sensor and/or detected via an input means,
an allocation between the type/sort of a plastic and in case a) a set-point temperature in the extruder and/or at the inlet of the extruder and/or in case b) a set-point load of the drive of the extruder is read from a memory and
the set-point temperature/set-point load, which corresponds to the identified/inputted type/sort of the plastic, is loaded into an open loop control/closed loop control for controlling the tempering device.

Accordingly, it is also advantageous if the presented device has a sensor for identifying the type/sort of the processed plastic and/or an input means for inputting the type/sort of the processed plastic,
a memory with an allocation, stored therein, between the type/sort of the plastic and in case a) a set-point temperature in the extruder and/or at the inlet of the extruder and/or in case b) a set-point load of the drive of the extruder and
means for loading the set-point temperature/set-point load, which corresponds to the identified/inputted type/sort of the plastic, into the open loop control/closed loop control. Thereby, different materials can be processed in an advantageous manner. This is advantageous in particular in connection with devices which are used for the recycling of plastic, because there a particularly large number of different plastics accumulate. Often, it is not even known which plastic or respectively which plastic mixtures are to be processed. Through the use of the above-mentioned sensor or respectively of the said input device, the type/sort of the processed plastic can, however, be established and the device can be adjusted thereto, so that in particular a clogging of the extruder inlet or respectively a sticking of plastic particles thereon is just prevented. Thereby, maintenance activities on the disclosed devices can be largely prevented, or respectively maintenance intervals are extended, on the one hand owing to the extruder inlet remaining free, on the other hand also owing to the gentle mode of operation of the extruder. In addition, the required drive output for the extruder or respectively the overall length of the extruder is relatively small and the material quality which is obtained is high.

In the presented variant, control can generally take place by means of a set-point temperature in the extruder and/or at the inlet of the extruder, when in the course of the conveying screw and/or in the course of the extruder at least one temperature sensor is arranged (case a) or by means of a set-point load of the drive of the extruder, when means are provided for detecting a load of a drive of the extruder (case b).

The input means can be formed for example by a keyboard, a touchscreen or, for example, also by a reading device for a storage medium, on which the type/sort of the processed plastic and, if applicable, also the allocation to a set-point temperature/set-point load is stored.

In a further particularly advantageous variant of the presented method,
in case a) an allocation between the type/sort of a plastic and a set-point temperature profile along at least a portion of the transport course of the plastic particles, containing the set-point temperature in the extruder and/or at the inlet of the extruder, and/or in case b) an allocation between the type/sort of a plastic and a set-point load profile along at least a portion of the transport course of the plastic particles, containing the set-point load of the drive of the extruder, are read from the memory and
the set-point temperature profile/set-point load profile or parts thereof are loaded into further open loop control circuits/closed loop control circuits in the transport course of the plastic particles, which are provided for controlling a temperature of the plastic particles. Accordingly, a particularly advantageous embodiment of the disclosed device is distinguished in that
in the memory in case a) an allocation between the type/sort of a plastic and a set-point temperature profile along at least a portion of the transport course of the plastic particles, containing the set-point temperature in the extruder and/or at the inlet of the extruder, and/or in case b) an allocation between the type/sort of a plastic and a set-point load profile along at least a portion of the transport course of the plastic particles, containing the set-point load of the drive of the extruder, is stored and
further open loop control circuits/closed loop control circuits in the transport course of the plastic particles are provided, by which the temperature of the plastic particles is able to be influenced and into which the said set-point temperature profile/set-point load profile or parts thereof are able to be loaded.

In particular in this context, it is also advantageous if the device has a plurality of temperature sensors arranged in the transport course of the plastic particles. In this variant, not only is a single set-point temperature prescribed selectively, but a set-point temperature profile along at least a portion of the transport course of the plastic particles, which leads through the conveying screw and the extruder. Thereby, the device can be adjusted even better to the type/sort of the processed plastic.

Generally, it is also conceivable that the method mentioned above for a set-point temperature profile (case a) is carried out in an analogous manner alternatively or additionally by means of a set-point load profile (case b). This is possible in particular when several drive motors are integrated into the transport course of the plastic particles. For example, the melting of the plastic particles can take place in several extruder stages which are driven independently of one another, or also several conveying screws which are driven independently of one another can be provided.

In particular, the temperature of the plastic particles, depending on type/sort in their entire transport course or up to a position in the extruder can be
constantly increasing or
constantly increasing, but substantially constant in the course of the conveying screw or
constantly increasing, but falling in the course of the conveying screw.

The first case is suitable in particular for plastics to which relatively little energy is supplied by friction in the conveying screw, or respectively plastics which have a comparatively high melting point. Examples of these are polyamide (PA) and polyethylene terephthalate (PET). The other two cases concern plastics to which a relatively large amount of energy is supplied through friction in the conveying screw, or respectively plastics which have a comparatively low melting point. Examples of these are polyolefins and ethylene vinyl acetate (EVA).

In a further advantageous variant embodiment, the conveying screw has comminution means arranged thereon, which are formed in particular by teeth and/or by continuous cutters and/or by blades. In this way, the material conveyed into the conveying screw can be further communited, before it reaches the extruder. Therefore, material of optimum size can be fed to the extruder, whereby a proper intermixing and a proper melting of the material can be guaranteed, and a clogging of the extruder can be prevented. The conveying screw can therefore also be (partly) regarded as a processing drum/comminution screw, or respectively can include this function.

The conveying screw can be occupied continuously by cutters and/or teeth and/or blades, or can have these only in a (continuous) partial region (i.e. in a comminution region), which adjoins a start region and/or end region, in which no cutters, teeth or blades are arranged. On the conveying screw, continuous cutters, teeth and blades can be used respectively alone or in any desired combination.

“Continuous cutters” extend substantially over the entire length of the conveying screw or respectively over the entire length of a comminution region. In particular, the continuous cutters can run helically or axially. A plurality of continuous cutters can be distributed over the circumference of the conveying screw, or the conveying screw has only one continuous cutter. On rotation of the conveying screw, the continuous cutters are moved substantially transversely to their longitudinal extent, or respectively the rotation of the conveying screw brings about a movement with such a transverse component. The separation of the plastic particles therefore takes place principally by shearing.

“Teeth” can be regarded as interrupted cutters or cutters with gaps. Their cutters can also run helically or axially and their cutters are also moved transversely to their longitudinal extent on rotation of the conveying screw. The separation of the plastic particles therefore takes place principally by shearing and tearing.

“Blades” have no distinct axial extent, and their cutters extend substantially radially outwards. On rotation of the conveying screw, the cutters are again moved transversely to their longitudinal extent, the plane of the “blade back”, however, stands substantially in a normal manner onto the rotation axis of the conveying screw. The separation of the plastic particles takes place principally by cutting.

Generally, an exact classification of the separation methods is scarcely possible, in particular when the cutters are not aligned precisely axially or precisely radially. Generally, the plastic particles are therefore comminuted by shearing and tearing and cutting.

Finally, it is favourable if in the region of the conveying screw, fixed counter cutters/counter blades/counter teeth are arranged, cooperating with its continuous cutters/blades, teeth (in particular in the comminution region thereof). Thereby, the cutting performance of the conveying screw is improved. In particular with the provision of blades and counter blades, the separation of the plastic particles no longer takes place necessarily predominantly by cutting, but rather, if applicable, also by shearing.

At this point, it is noted that the variants disclosed with regard to the device for processing thermoplastic material, and advantages resulting therefrom, also refer correspondingly to the embodiments of the operating method according to the invention, and vice versa.

For a better understanding of the invention, the latter is explained in further detail with the aid of the following figures.

There are shown respectively in highly simplified, diagrammatic illustration:

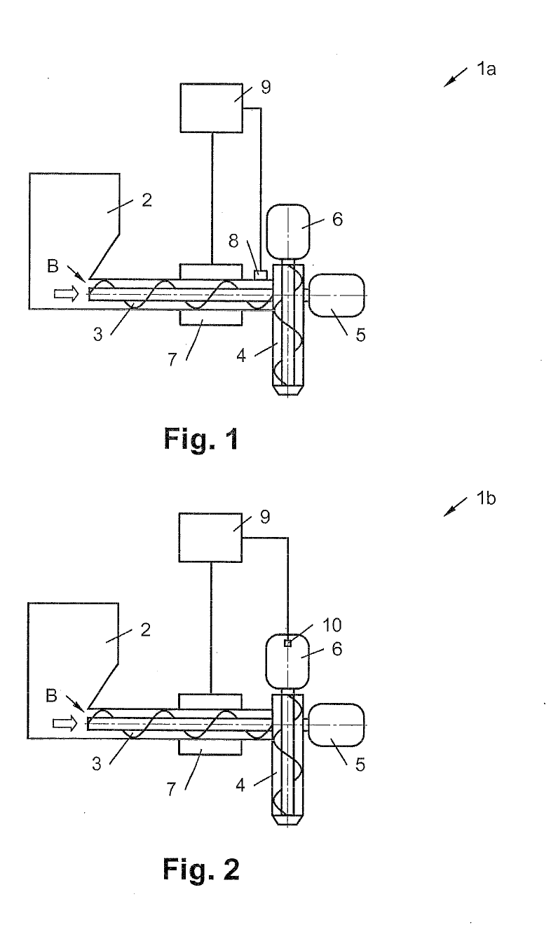

FIG. 1 a first exemplary and diagrammatically illustrated device for processing thermoplastic material with a tempering device and with a control via a temperature sensor in the region of the inlet into the extruder;

FIG. 2 a second exemplary device with a control via the load of the drive of the extruder;

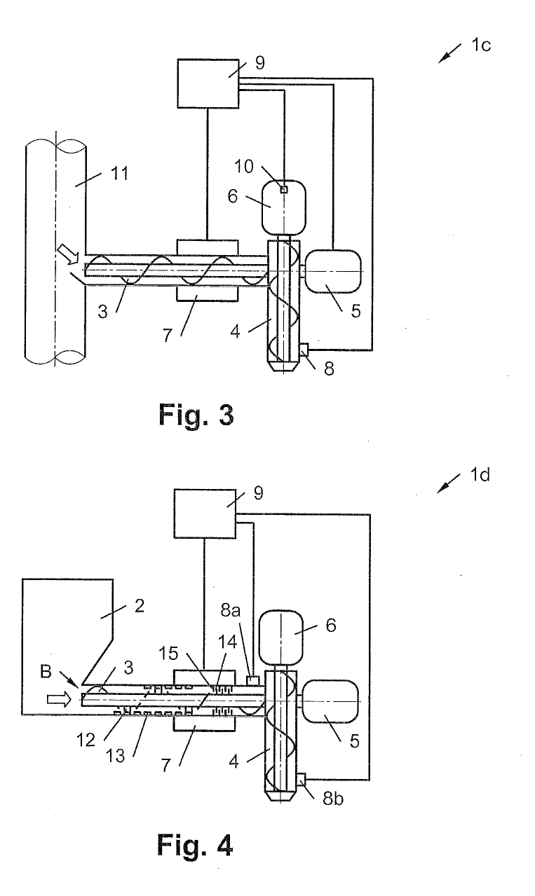

FIG. 3 a further exemplary device with an expanded control;

FIG. 4 as FIG. 1, only with teeth and blades on the conveying screw and with a temperature sensor on the extruder nozzle;

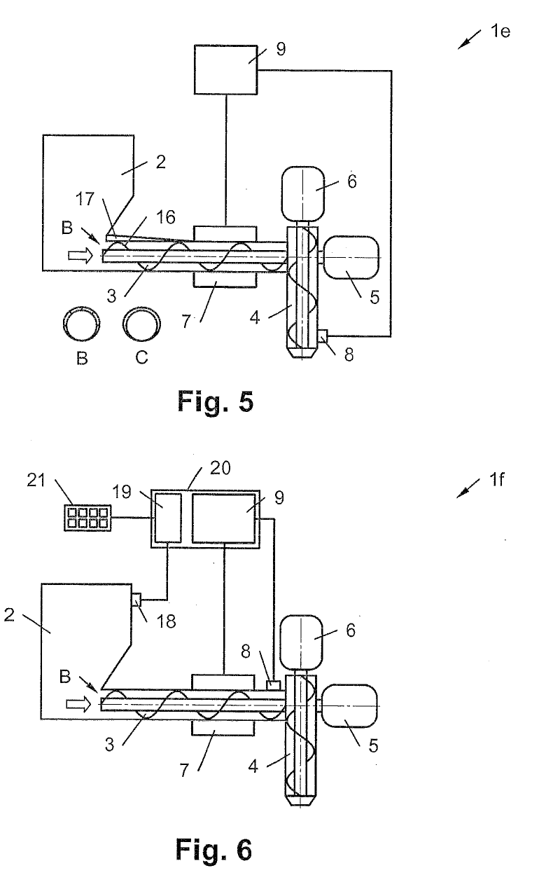

FIG. 5 as FIG. 1, only with continuous blades on the conveying screw;

FIG. 6 a device with a sensor for identifying, and input means for inputting, the type/sort of the processed plastic;

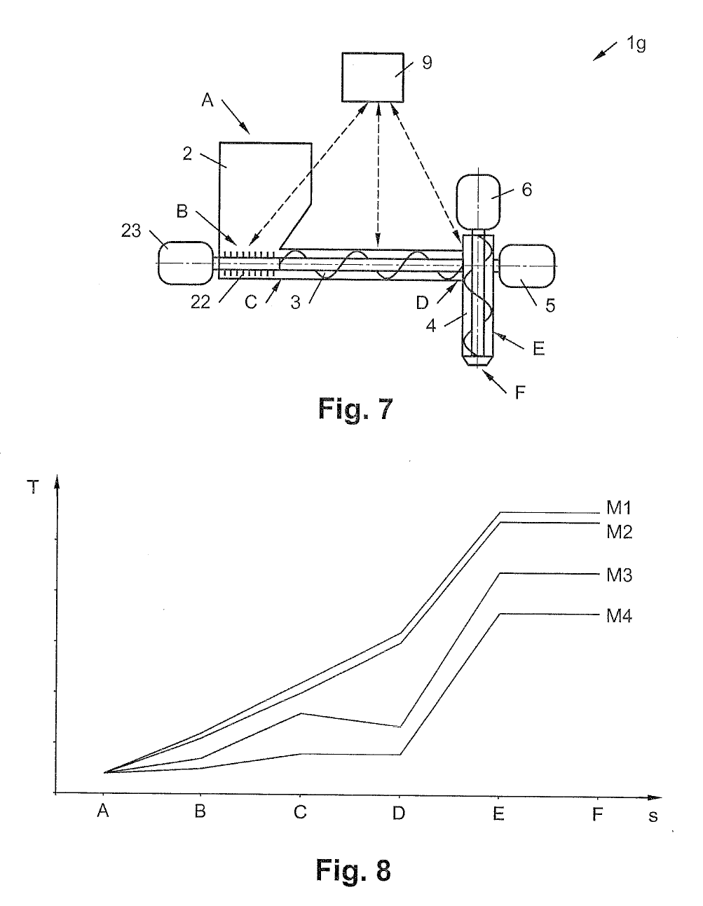

FIG. 7 a device having several influence points in the course of the transport path of the plastic particles and

FIG. 8 temperature profiles for four different types/sorts of plastic particles along their transport path through the device.

By way of introduction, it is to be stated that in the variously described embodiments, the same parts are provided with the same reference numbers or respectively with the same component designations, wherein the disclosures contained in the entire description can be transferred correspondingly to identical parts with identical reference numbers or respectively with identical component designations. The location indications selected in the description, such as e.g. above, below, lateral etc., refer to the directly described and illustrated figure and, with a change of location, are to be transferred correspondingly to the new location.

FIG. 1 shows a device 1a for processing thermoplastic material, which comprises a storage container 2 for receiving plastic particles, and a conveying screw 3 connected to the storage container 2 at a transfer opening B, and an extruder 4 connecting to the conveying screw 3. The conveying screw 3 is driven by a first drive motor 5, and the extruder 4 is driven by a second drive motor 6. The conveying screw 3 and the extruder 4 intersect one another in the example which is shown. However, it is pointed out that FIG. 1 is a purely diagrammatic illustration, and the conveying screw 3 and the extruder 4 can also be arranged differently with respect to one another, in particular coaxially. It is also conceivable that the conveying screw 3 and the extruder 4 are driven by a single motor.

In addition to the components which have already been mentioned, the device 1a has a tempering device 7 arranged in the course of the conveying screw 3. Thereby, the conveying screw 3 or respectively the plastic particles conveyed therewith can be temperature-controlled during the conveying. Depending on the configuration of the tempering device 7, heat can be supplied to or removed from the plastic particles via the tempering device 7, whereby these are heated or cooled accordingly.

The tempering device 7 can be formed by a heating device, a cooling device or a combined heating and cooling device. Furthermore, the temperature device 7 can be operated by electrical current or by a heat carrier. In the case of operation by current, the tempering device 7 can be configured in particular as a heating coil. If the tempering device 7 is operated with a heat carrier, it can have, for example, a coiled tube which is flowed through by the heat carrier, which can be gaseous or liquid and can heat or cool the tempering device 7.

In FIG. 1 the tempering device 7 is illustrated as a heating and/or cooling sleeve arranged around the conveying screw 3. This is indeed advantageous, but not compulsory. It is also conceivable that the tempering device 7 is alternatively or additionally integrated in the shaft of the conveying screw 3. In this way, the heat transfer between the plastic particles and the tempering device 7 can take place particularly well.

In FIG. 1 the tempering device 7 is illustrated in addition somewhat in front of the inlet of the extruder 4. However, it is also conceivable that the tempering device 7 directly adjoins the extruder 4 or even projects over into the region of the extruder 4.

Generally, the supply and/or removal of heat is adjustable. For example, for this, the current which flows through a heating coil of the tempering device 7 can be adjustable, for instance with the aid of a transistor or thyristor. The adjusting of voltage and/or current of an electrical energy source connected to the heating coil would of course also be possible. If the operation with a liquid or gaseous heat carrier is provided, then the inflow to the tempering device 7 can be adjustable with the aid of a valve, which is connected into the flow or return, or else via the adjusting of an output of a pump or of a compressor, which is connected in circuit of the heat carrier. It is also conceivable that the heat carrier can be directed in an adjustable manner via a bypass. Additionally or alternatively, provision can also be made that the temperature of the heat carrier can be adjusted via a heat exchanger of a heating or cooling circuit, which is not illustrated.

Consequently, the said transistor/thyristor, the adjustable electrical energy source, the said valve, the pump/the compressor, or also the said heat exchanger can form influencing means of the tempering device 7, which are connected for example to the outlet of the open loop control/closed loop control 9 and accordingly are actuated by the open loop control/closed loop control 9.

In the example illustrated in FIG. 1, the supply and/or removal of heat can be adjusted or regulated furthermore as a function of a measured temperature. For this purpose, the device 1a has a temperature sensor 8 for detecting a temperature in the region of the inlet of the extruder 4, and a closed loop control 9 connected to the temperature sensor 8 and to the tempering device 7. The closed loop control 9 is arranged to increase the supply of heat through the tempering device 7 when the temperature at the inlet of the extruder 4 falls, and vice versa. This means that the tempering device 7 is heated when a temperature at the inlet of the extruder 4 falls, and is cooled when a temperature rises there.

Through the above-mentioned variant of the device 1 a, a representative for the case designated by “a” is realized. This means that at least one temperature sensor 8 is arranged in the course of the conveying screw 3 and/or in the course of the extruder 4, and means for influencing the tempering device 7 and an open loop control/closed loop control 9 connected with the at least one temperature sensor 8 and with the influencing means of the tempering device 7 are provided.

In the example which is shown, the temperature sensor 8 is in practical terms arranged in the transport direction of the conveyed plastic particles after the tempering device 7. In this way, a presettable (set-point) temperature of the plastic particles delivered to the extruder 4 can be regulated and can thereby be maintained particularly well.

Basically, however, it is also possible that the temperature sensor 8 is arranged before the tempering device 7 in transport direction. In this case, for example, a control can be provided for the tempering device 7, which controls the power of the tempering device 7 by means of the temperature of the delivered plastic particles. It is also conceivable that temperature sensors 8 are arranged before the tempering device 7 and after the tempering device 7.

Through the proposed provisions, a set-point temperature can be reached with a high degree of reliability in the extruder 4 and/or at the inlet of the extruder 4. By means of the tempering device 7, material supplied to the extruder 4 can be heated, for example when this has been delivered with a very low temperature and/or has a high thermal capacity and/or has a high melting temperature, and/or has not been heated in the expected manner through friction, shearing work and compression in the conveying tube. In particular, however, it is also conceivable that the plastic particles which are fed to the extruder 4 are cooled by means of the tempering device 7, for example when material has been delivered at a very high temperature and/or has a low thermal capacity and/or has a lower melting temperature and/or has been heated excessively by friction, shearing work and compression in the conveying tube.

FIG. 2 shows now a device 1b, which is very similar to the device 1a shown in FIG. 1. In contrast thereto, the closed loop control 9, however, is not connected to the temperature sensor 8, but rather to means 10 for detecting a load of the drive 6 of the extruder 4. Accordingly, the supply and/or removal of heat in the example illustrated in FIG. 2 is adjusted or regulated as a function of a load of the extruder 4. In particular, the supply of heat is increased when the load of the extruder 4 increases, and vice versa. This means that the tempering device 7 is heated when the load of the extruder 4 increases, and is cooled when the load of the extruder 4 falls.

Through the said variant of the device 1b, a representative is realized for the case designated by “b”. This means that means 10 for detecting a load of a drive 6 of the extruder 4, means for influencing the tempering device 7 and a closed loop control 9 connected to the detection means 10 and to the influencing means are provided.

To determine the load of the extruder 4, the detection means 10 can be configured as a sensor for measuring a rotation speed of the drive 6 of the extruder 4 (e.g. as a digital incremental encoder), as a sensor for measuring a current received by this drive 6 (e.g. as a voltage meter on a current-sensing resistor), or as a sensor for measuring the torsion of a shaft in the drive 6 (e.g. as a measuring bridge with strain gauge). When the rotation speed of the drive 6 decreases, the current received by the drive 6 increases, or the torsion of a shaft in the drive 6 increases, this is an indication of a more intensive load of the extruder 4.

At this point, it is pointed out that the drive 6 is not necessarily solely a motor, but rather the drive 6 can also, for example, have a gear unit. The above-mentioned rotation speed and the above-mentioned torsion can therefore also be taken at a component in the gear unit.

FIG. 3 shows now a further example of a device 1c, which is very similar to the devices 1a and 1b illustrated in FIGS. 1 and 2. In the device 1c, the closed loop control 9 is connected both to a temperature sensor 8 of the extruder 4 and also to means 10 for detecting a load of the drive 6 of the extruder 4. Control of the tempering device 7 can therefore take place in a particularly differentiated manner.

In the device 1c in particular also the drive motor 5 of the conveying screw 3 is connected to the control unit 9 and is integrated into the open loop control/closed loop control of the device 1c. For example, the rotation speed of the conveying screw 3 can be lowered when load of the extruder 4 increases and vice versa, in particular synchronously to an increase of the temperature.

In contrast to FIG. 1, the temperature sensor 8 is arranged in the region of the outlet of the extruder 4. Thereby, the closed loop control 9 can regulate the temperature at the outlet of the extruder 4, whereby the proper melting of the plastic particles can be controlled well. Of course, the temperature sensor 8 could, however, also be arranged at the inlet of the extruder 4, as is illustrated in FIG. 1.

It can also be seen from FIG. 3 in particular that the device 1c does not necessarily have a container 2, but rather the conveying screw 3, as illustrated, can be connected to a conveying tube 11. Via the conveying tube 11, plastic particles are not only conveyed to the conveying screw 3, but also to other (not illustrated) units. In particular, the transport direction occurs from top to bottom. Through the movement of the plastic particles and the projection protruding into the conveying tube 11, some of the material transported in the conveying tube 11 cam be branched off and conveyed into the conveying screw 3.

In the examples shown hitherto, the conveying screw 3 is aligned in horizontal direction and the transfer opening B is aligned in vertical direction. This is, indeed, advantageous, but is not compulsory. Generally, it is of course also conceivable that the conveying screw 3 and/or the cross-section of the transfer opening B are aligned obliquely.

Generally, it is also advantageous if the conveying screw 3 has radially arranged cutters, blades or teeth. In this way, the material which is conveyed into the conveying screw 3 can be further comminuted before it reaches the extruder 4. The conveying screw 3 can therefore also be regarded (partly) as a processing drum/comminution screw, or can respectively include this function.

FIG. 4 shows by means of a device 1d, which corresponds substantially to the device 1a illustrated in FIG. 1, how such a conveying screw 3 can be configured. In practical terms, the conveying screw 3 of the device 1d comprises teeth 12 and counter teeth 13 and blades 14 and counter blades 15, wherein the teeth 12 and counter teeth 13 are arranged more in the front region of the conveying screw 3, and the blades 14 and counter blades 15 are arranged in the end region of the conveying screw 3. In this way, the material conveyed into the conveying screw 3 is further comminuted before it reaches the extruder 4. Therefore, material of optimium size can be fed to the extruder 4, whereby a proper intermixing and a proper melting of the material can be guaranteed and a clogging of the extruder 4 can be prevented.

In contrast to FIG. 1, in addition to a temperature sensor 8a arranged in the region of the inlet of the extruder 4, a further temperature sensor 8b is provided, which is arranged in the region of the nozzle of the extruder 4 (cf. also FIG. 3). Thereby, both the temperature of the plastic particles at the inlet of the extruder 4 and also their temperature at the outlet of the extruder 4 can be taken as the basis for the closed loop control 9. The process of preparing the plastic particles can therefore be controlled particularly well. In particular, a heating (not illustrated) of the extruder 4 can be connected to the closed loop control 9. Thereby, a first control loop can be formed, which comprises the first temperature sensor 8a and the tempering device 7, and a second control loop can be formed which comprises the second temperature sensor 8b and the extruder heating. The two control loops can operate independently of each other, or a further control loop can be superordinate to these.

FIG. 5, finally, shows an example of a device 1c which is very similar to the device 1d illustrated in FIG. 4. In this variant, however, the conveying screw 3 has no teeth 12 and no blades 14, but rather has continuous cutters 16. These cutters 16 interact with fixed cutters 17, whereby the supplied material is also comminuted.

The fixed cutters 17 can be configured, for example, as axially aligned cutters (see also the front view B) or else likewise can run helically (see the front view C). It is particularly advantageous if the pitch of the fixed helical cutters 17 is different to that of the cutters 16 of the conveying screw 3, because then load peaks in the drive torque are prevented. The helical cutters 17 can be wound in the same direction as the cutters 16 of the conveying screw 3 or else in the opposite direction thereto. Finally, it would also be conceivable that the fixed cutters 17 stand in a normal manner to the axis of the conveying screw 3.

Generally, it is advantageous if the fixed cutters 17 are arranged only in the upper and in the lateral region of the conveying screw 3, because in this way it is prevented that material collects in the lower region of the conveying screw 3, which material is not transported away. In addition, the tube in which the conveying screw 3 runs tapers in a funnel shape, whereby the drawing in of the plastic particles into the conveying screw 3 is promoted. Of course, the said eccentric configuration and/or the said funnel-shaped structure is also suitable for the teeth 12 and blades 14 illustrated in FIG. 4. Conversely, an arrangement coaxial to the conveying screw 3 and/or a cylindrical arrangement is also possible for the cutters 17 of FIG. 5. Finally, it is also conceivable that the conveying screw 3 has cutters 12, blades 14 and teeth 16 or any desired combination thereof.

FIG. 6 shows now a further variant of a device 1f, which has a sensor 18 for identifying the type/sort of the processed plastic, a memory 19 with an allocation, stored therein, between the type/sort of the plastic and a set-point temperature in the extruder 4 and/or at the inlet of the extruder 4 and means for loading the set-point temperature, which corresponds to the identified type/sort of the plastic, into the open loop control/closed loop control 9. In the example which is shown, the memory 19 and the open loop control/closed loop control 9 are part of a process computer 20. Of course, the memory 19 and the open loop control/closed loop control 9 can also form independent units.

In this variant, the temperature at the temperature sensor 8 is therefore not only regulated, but also it is established which set value is to be taken as the basis for the control. Basically, various sensors 18 can be used for detecting the type/sort of the plastic. For example, it can operate according to the principle of spectral analysis. Under certain circumstances, a continuous determining of the type/sort of the plastic is not possible or is only possible to a restricted extent owing to the required measurement time. It is therefore also conceivable that the measurement is carried out at the start of a batch, and the result forms the basis of the following processing.

Through the proposed provisions, the most varied of materials can be processed in an advantageous manner. This is advantageous in particular in connection with devices 1f, which are used for the recycling of plastic, because there a particularly large number if different plastics accumulate. Often, it is not even known which plastic or respectively which plastic mixtures are to be processed. However, by the use of the above-mentioned sensor 18, the type/sort of the processed plastic can be established and the device if can be adjusted thereto.

In the presented variant, control can take place generally, as stated above, by means of the set-point temperature in the extruder 4 and/or at the inlet of the extruder 4, when in the course of the conveying screw 3 and/or in the course of the extruder 4 a temperature sensor 8, 8a, 8b is arranged (case a). Additionally or alternatively, control can also take place by means of a set-point load of the drive 6 of the extruder 4 when means 10 are provided for detecting a load of the drive 4 of the extruder 6 (case b).

Alternatively or additionally to the sensor 18, input means 21 can also be provided for inputting the type/sort of the processed plastic, as is illustrated in FIG. 6. In this way, the type/sort can be inputted by a machine operator, for example by his selecting one or more plastics from a presented table. For example, the results of a laboratory analysis or information from a supplier can form the basis of the input. The input means 21 can be formed for example by a keyboard, a touchscreen or, for example, also by a reading device for a storage medium, on which the type/sort of the processed plastic and, if applicable, also the allocation to a set-point temperature/set-point load is stored.

In addition to the above statements, it is also noted that in the memory 19 also an allocation between the type/sort of a plastic and a set-point temperature profile along at least a portion of the transport course of the plastic particles, containing the set-point temperature in the extruder 4 and/or at the inlet of the extruder 4, can be stored. In addition, further open loop control circuits/closed loop control circuits can be provided in the transport course of the plastic particles, by which the temperature of the plastic particles is able to be influenced, and into which the said set-point temperature profile or parts thereof are able to be loaded.

In this variant, therefore, not only a single set-point temperature is prescribed selectively, but rather a set-point temperature profile along at least a portion of the transport course of the plastic particles, which leads at least through the conveying screw 3 and the extruder 4. Thereby, the device if can be adjusted even better to the type/sort of the processed plastic.

FIG. 7 shows an example for this, in which the open loop control/closed loop control 9 has influence at several points of a device 1g, as is illustrated in a simplified manner by dashed arrows. For this purpose, several temperature sensors 8, 8a, 8b (not illustrated explicitly in FIG. 7) can be provided, arranged in the transport course of the plastic particles. In FIG. 7, furthermore, a comminution shaft 22 is provided, able to be driven independently of the conveying screw 3, with blades arranged thereon. For the drive thereof, the device 1g therefore also comprises a further motor 23. By means of this comminution- or blade shaft 22, the size of the plastic particles delivered to the extruder can be adjusted independently of the material flow through the conveying screw 3. When the rotation speed of the comminution- or blade shaft 22 is increased with respect to the rotation speed of the conveying screw 3, the plastic particles are comminuted more intensively, and vice versa.

In particular, the temperature of the plastic particles, depending on the type/sort, in the entire transport course thereof up to a position in the extruder 4, can be
constantly increasing or
constantly increasing, but substantially constant in the course of the conveying screw or
constantly increasing, but falling in the course of the conveying screw,
   as is illustrated by way of example in FIG. 8. In practical terms, FIG. 8 shows several temperature profiles through the device 1g. In practical terms, the temperatures T are presented at several points A . . . F distributed over the path s. Point A designates here the inlet of the storage container 2, point B the inlet to the comminution- or blade shaft 22, point C the inlet to the conveying screw 3, point D the inlet to the extruder 4, point E a location in the extruder 4 and point F the outlet or respectively the nozzle of the extruder 4.

In practical terms, the temperature profiles for four different materials M1 . . . M4 are presented. For the materials M1 and M2, the temperature T is rising constantly in the entire transport course up to position E. These profiles are suitable in particular for plastics to which relatively little energy is supplied through friction in the conveying screw 3, or respectively plastics which have a comparatively high melting point. For example, for the material M1 polyethylene terephthalate (PET) can be provided, and polyamide (PA) for the material M2.

For the materials M3 and M4, the temperature T is rising constantly in the entire transport course up to the position E, but is falling in the course of the conveying screw 3. These profiles are suitable in particular for plastics to which a relatively large amount of energy is supplied through friction in the conveying screw 3, or respectively plastics which have a comparatively low melting point. For example, polyolefin can be provided for the material M3, and ethylene vinyl acetate (EVA) for material M4.

The materials M3 and M4 are therefore cooled by the tempering device 7 in the course of the conveying screw 3, in order to prevent or at least reduce a clogging or sticking of the extruder opening D or respectively a sticking of the plastic particles thereon. In this connection, it is also advantageous in particular if a cooling power of the tempering device 7 is greater than a power supplied to the plastic particles in the conveying screw 3 through friction. In a further preferred variant, the cooling power of the tempering device 7 is greater than a drive power of the conveying screw 4. The latter is generally easier to determine than a power supplied to the plastic particles in the conveying screw 4 through friction, whereby also the dimensioning of the tempering device 7 is simplified. A slight oversizing which has possibly taken place thereby can serve as security.

In the present example, reference was made to a transport path up to the position E. Starting from this position E, the temperature T no longer increases up to the nozzle F. However, it is also conceivable that the temperature T also increases from the position E up to the nozzle F. In this case, the above considerations apply for the entire transport path of the plastic particles through the device 1g.

In the above example, the presented method is carried out on the basis of a set-point temperature profile and with the aid of several temperature sensors 8, 8a, 8b arranged in the transport course of the plastic particles. Generally, however, it is also conceivable that the addressed method is carried out in an analogous manner alternatively or additionally by means of a set-point load profile. This is possible in particular when several drive motors are integrated into the transport course of the plastic particles. In the illustrated examples, these are the first drive 5 for the conveying screw 3, the second drive 6 for the extruder 4 and the motor 23 for comminution shaft/blade shaft 22. However, it would also be conceivable that the melting of the plastic particles takes place in several extruder stages, driven independently of one another, or the transport of the plastic particles is provided by several conveying screws 3 driven independently of one another. In this case, the set-point loads of these drives can also be integrated into the set-point load profile.

The example embodiments show possible variant embodiments of a device 1a . . . 1g for processing thermoplastic material, and methods for their operation, wherein at this point it is noted that also various combinations of the individual variant embodiments with one another are possible.

In particular, it is pointed out that the presented control principles are not necessarily linked to the mechanical characteristics of the structural form of the device 1a . . . 1g which was selected for illustration. This means that the examples are exchangeable with one another with regard to their characteristics concerning control technique, and as regards their mechanical structure. For example, the control principle presented in FIG. 1 can also be applied with a conveying screw 3 according to FIG. 4 or 5 or respectively in connection with a conveying tube 11. The control principle illustrated in FIG. 3 can also be applied in devices 1a, 1b, 1d, 1e, 1f, 1g and so on.

In particular, it is noted that a device 1a . . . 1g in reality can also comprise more or fewer components than are illustrated.

Finally, for the sake of good order, it is also pointed out that for a better understanding of the structure of the device 1a . . . 1g, the latter, or respectively its components, have partly been illustrated not to scale and/or enlarged and/or reduced in size.

The problem forming the basis of the independent inventive solutions can be taken from the description.

### REFERENCE LIST

1a . . . 1g device for processing thermoplastic material
2 storage container
3 conveying screw
4 extruder
5 first drive (for conveying screw)
6 second drive (for extruder)
7 tempering device
8, 8a, 8b temperature sensor
9 open loop control/closed loop control
10 detection means for the load of the extruder
11 conveying tube
12 teeth (on conveying screw)
13 counter teeth
14 blade (on conveying screw)
15 counter blade
16 continuous cutters (on conveying screw)
17 counter cutters
18 sensor for detecting the type/sort of the plastic
19 table/memory with allocation of plastic type/sort vs. set-point temperature/set-point load
20 process computer
21 input means for inputting the type/sort of the plastic
22 comminution shaft/blade shaft
23 motor for comminution shaft/blade shaft
A storage container inlet
B transfer opening/inlet to the comminution shaft/blade shaft
C inlet to the conveying screw
D inlet to the extruder
E position within extruder
F extruder outlet/nozzle
M1 . . . . M4 material
s path
T temperature

1-24. (canceled)

25. A device (1a . . . 1g) for processing thermoplastic material, comprising
a storage container (2) for receiving plastic particles or a conveying line (11) for the transport of plastic particles,
a conveying screw (3) connected to the storage container (2)/the conveying line (11) at a transfer opening (B) and
an extruder (4) connecting to the conveying screw (3),
a tempering device (7) arranged in the course of the conveying screw (3) and
a) at least one temperature sensor (8, 8a, 8b), which is arranged in the course of the conveying screw (3) and/or in the course of the extruder (4), means for influencing the tempering device (7) and an open loop control/closed loop control (9) connected to the at least one temperature sensor (8, 8a, 8b) and to the means for influencing the tempering device (7) and/or
b) means (10) for detecting a load of a drive (6) of the extruder (4), means for influencing the tempering device (7) and a closed loop control (9) connected to the detection means (10) and to the influencing means,
further comprising
a sensor (18) for detecting the type/sort of the processed plastic and/or an input means (21) for inputting the type/sort of the processed plastic,
a memory (19) with an allocation, stored therein, between the type/sort of the plastic and in case a) a set-point temperature in the extruder (4)/at the inlet of the extruder (4), and/or in case b) a set-point load of the drive (6) of the extruder (4) and
means for loading the set-point temperature/set-point load, which corresponds to the detected/inputted type/sort of the plastic, into the open loop control/closed loop control (9).

26. The device (1a . . . 1g) according to claim 25, wherein the tempering device (7) is formed by a heating device, a cooling device or a combined heating- and cooling device.

27. The device (1a . . . 1g) according to claim 26, wherein a cooling power of the cooling device or of the combined heating- and cooling device is greater than a power supplied to the plastic particles in the conveying screw (3) by friction.

28. The device (1a . . . 1g) according to claim 25, wherein the at least one temperature sensor (8, 8a, 8b) in case a) is arranged in transport direction after the tempering device (7).

29. The device (1a . . . 1g) according to claim 25, wherein the at least one temperature sensor (8, 8a, 8b) in case a) is arranged in the region of the transition between the conveying screw (3) and the extruder (4).

30. The device (1a . . . 1g) according to claim 25, wherein the closed loop control (9) in case a) is arranged to increase the heat supply through the tempering device (7) when a temperature (T) in the extruder (4)/at the inlet of the extruder (4) falls, and vice versa.

31. The device (1a . . . 1g) according to claim 25, wherein the closed loop control (9) in case b) is arranged to increase the heat supply through the tempering device (7) when a load of the extruder (4) increases, and vice versa.

32. The device (1a . . . 1g) according to claim 25, further comprising a plurality of temperature sensors (8, 8a, 8b) arranged in the transport course of the plastic particles.

33. The device (1a . . . 1g) according to claim 25, wherein
in the memory (19) an allocation between the type/sort of a plastic and in case a) a set-point temperature profile along at least a portion of the transport course of the plastic particles, containing the set-point temperature in the extruder (4)/at the inlet of the extruder (4), and/or in case b) an allocation between the type/sort of a plastic and a set-point load profile along at least a portion of the transport course of the plastic particles, containing the set-point load of the drive (6) of the extruder (4), is stored and
further open loop control circuits/closed loop control circuits are provided in the transport course of the plastic particles, by which the temperature (T) of the plastic particles is able to be influenced and into which the said set-point temperature profile/set-point load profile or parts thereof are able to be loaded.

34. The device (1a . . . 1g) according to claim 25, wherein the conveying screw (3) has comminution means (12, 14, 16) arranged thereon.

35. The device (1a . . . 1g) according to claim 34, wherein the comminution means are formed by teeth (12) and/or blades (14) and/or continuous cutters (16).

36. The device (1a . . . 1g) according to claim 35, wherein in the region of the conveying screw (3), fixed counter teeth (13)/counter blades (15)/counter cutters (17), interacting with its teeth (12)/blades (14)/continuous cutters (16), are arranged.

37. A method for processing thermoplastic material by means of a device (1a . . . 1g), which comprises a storage container (2) for receiving plastic particles or a conveying line (11) for the transport of plastic particles, a conveying screw (3) connected to the storage container (2)/the conveying line (11) at a transfer opening (B), and an extruder (4) connecting to the conveying screw (3), wherein the plastic particles are tempered in the course of the conveying screw (3) by a tempering device (7),
wherein
the type/sort of the processed plastic is identified by a sensor (18) and/or is detected via an input means (21),
an allocation between the type/sort of a plastic and a set-point temperature in the extruder (4)/at the inlet of the extruder (4) and/or in a set-point load of the drive (6) of the extruder (4) is read from a memory (19) and
the set-point temperature/set-point load, which corresponds to the identified/inputted type/sort of the plastic, is loaded into an open loop control/closed loop control (9) for controlling the tempering device (7).

38. The method according to claim 37, wherein the plastic particles are tempered by the supply or removal of heat via the tempering device (7).

39. The method according to claim 38, wherein the supply and/or removal of heat is adjusted or controlled as a function of a temperature (T) in the extruder (4)/at the inlet of the extruder (4).

40. The method according to claim 39, wherein the removal of heat is intensified when the temperature (T) in the extruder (4)/at the inlet of the extruder (4) rises, and vice versa.

41. The method according to claim 38, wherein the supply and/or removal of heat is adjusted or controlled as a function of a load of the extruder (4).

42. The method according to claim 41, wherein the removal of heat is intensified when the load of the extruder (4) falls, and vice versa.

43. The method according to claim 41, wherein for determining the load of the extruder (4) a rotation speed of a drive (6) of the extruder (4), a current received by this drive (6) or the torsion of a shaft in the drive (6) is measured.

44. The method according to claim 37, wherein the plastic particles are cooled in the course of the conveying screw (3) by the tempering device (7).

45. The method according to claim 37, wherein
an allocation between the type/sort of a plastic and a set-point temperature profile along at least a portion of the transport course of the plastic particles, containing the set-point temperature in the extruder (4)/at the inlet of the extruder (4), and/or an allocation between the type/sort of a plastic and a set-point load profile along at least a portion of the transport course of the plastic particles, containing the set-point load of the drive (6) of the extruder (4), is read from the memory (19) and
the set-point temperature profile/set-point load profile or parts thereof is loaded into further open loop control circuits/closed loop control circuits in the transport course of the plastic particles, which are provided for controlling temperature (T) of the plastic particles.

46. The method according to claim 37, wherein the temperature (T) of the plastic particles according to type/sort in their entire transport course or up to a position in the extruder (4) is
constantly rising or
constantly rising, but substantially constant in the course of the conveying screw (3) or
constantly rising, but falling in the course of the conveying screw (3).
